(19) United States
(12) Patent Application Publication
(10) Pub. No.: US 2008/0122383 A1
(43) Pub. Date: May 29, 2008

(54) Led driver

(75) Inventor: Shun-ichi Katoh, Yamatokoriyama-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/976,053

(22) Filed: Oct. 19, 2007

(30) Foreign Application Priority Data
Nov. 27, 2006 (JP) 2006-318288

(51) Int. Cl. G09G 3/14; H05B 41/36

(52) U.S. Cl. 315/291

(57) ABSTRACT

An LED driver according to the present invention feeds an electric power to an LED circuit, which is either of a single LED or a plurality of LEDs serially connected together. The LED driver includes: a constant current circuit part serially connected to the LED circuit and adjusting a current flowing from an upstream to a downstream side thereof to a predetermined value; and a voltage adjustment part serially connected to the constant current circuit part and adjusting a potential difference between the upstream and downstream sides with a switching regulator. This therefore permits providing an LED driver capable of, while adopting a constant current driving method using a constant current circuit, easily minimizing unnecessary power consumption and respecting the permitted loss at the constant current circuit.

This application is based on Japanese Patent Application No. 2006-318288 filed on Nov. 27, 2006, the contents of which are hereby incorporated by reference.

### BACKGROUND OF THE INVENTION

1. Field of the Invention

The present invention relates to an LED driver as a device for illuminating an LED.

2. Description of Related Art

Conventionally adopted as LED drivers for illuminating an LED (Light Emitting Diode) are those which employ a resistance driving method using a constant voltage source and a resistor and those which employ a constant current driving method using a constant current source. FIG. 9 shows a circuit example of the resistance driving method.

The resistance driving method employs relatively simple structure, which can be achieved at low costs. However, the amount of a current flowing to the LEDs is influenced by a sum of voltage drop V_{F} in LEDs acting as loads (hereinafter referred to as load LEDs) serially connected together. Thus, a variation in the sum of voltage drop V_{F} in the load LEDs serially connected together may cause a luminance variation in the LEDs.

The constant current driving method described above serves as a driving method that lowers such a luminance variation. This method requires, in addition to a constant voltage source for feeding an electric power to a load LED, a constant current circuit. However, this method can achieve driving with a constant current without depending on the sum of voltage drop V_{F} in the load LEDs serially connected together, thus minimizing a luminance variation in the LEDs. For conventional technology, JP-UM-H4-135782 and JP-A-2002-207236 are to be referenced.

The LED driver using the constant current driving method described above can be realized by providing a constant voltage source and a constant current circuit. A difference between a voltage of this constant current source and a voltage required for the load LEDs (sum of voltage drop V_{F} in the load LEDs) needs to be dissipated by a constant current circuit part. Thus, if this difference is excessively larger than the voltage required at the constant current circuit part, the dissipation in the constant current circuit part increases, thus resulting in increased thermal loss.

As the constant voltage source, not the one prepared for driving an LED but the existing one providing a relatively high voltage is used in many cases in practice. Thus, such a difference between these two voltages is likely to become larger than the voltage required at the constant current circuit part, thus resulting in a high possibility of increased thermal loss. As a result, as shown in FIG. 10, in order to respect the permitted loss at the constant current circuit part, an external resistor needs be fitted to disperse the heat generated.

Moreover, with the constant current driving method, the luminance of the LED can be controlled by making this current value adjustable. However, in the circuit configuration shown in FIG. 10, even if an optimum resistance is selected for a maximum current driving the load LED, as a result of current fluctuation, there arises a current range where the loss at the constant current circuit part is large, which also causes a possibility of excess over the permitted loss at the constant current circuit part.

### SUMMARY OF THE INVENTION

To solve the problem described above, the present invention has been made, and it is an object of the invention to provide an LED driver capable of, while adopting a constant current driving method using a constant current circuit, easily minimizing unnecessary power consumption and respecting the permitted loss at the constant current circuit.

To achieve the object described above, an LED driver according to one aspect of the invention feeds an electric power to an LED circuit, which is either of a single LED or a plurality of LEDs serially connected together. The LED driver includes: a constant current circuit part serially connected to the LED circuit and adjusting a current flowing from an upstream to a downstream side thereof to a predetermined value; and a voltage adjustment part serially connected to the constant current circuit part and adjusting a potential difference between the upstream and downstream sides with a switching regulator.

This configuration makes it easy to keep a current flowing to the LED circuit at a predetermined value by the constant current circuit part. Moreover, since the voltage adjustment part is serially connected to the constant current circuit part, voltage adjustment by the voltage adjustment part so that voltage drop to be dissipated by the constant current circuit part becomes more appropriate permits reducing the dissipation by the constant current circuit part.

The voltage adjustment part adjusts a voltage with a switching regulator. This therefore permits minimizing unnecessary power consumption associated with step-down processing, and also makes it easy to, even in case of a voltage value change, respect the permitted loss by keeping constant the dissipation by the constant current circuit part following this change.

In the configuration described above, the LED driver may further include a voltage detection part for detecting a degree of voltage drop in the constant current circuit part, and adjustment made in the voltage adjustment part may be executed in accordance with a result of detection by the voltage detection part.

This configuration permits execution of voltage adjustment in the voltage adjustment part in accordance with the degree of voltage drop in the constant current circuit part. This therefore makes it easier to execute the voltage adjustment so that the voltage drop to be dissipated by the constant current circuit part becomes appropriate.

In the configuration described above, the LED driver may further include a voltage detection part for detecting a degree of voltage drop in the LED circuit, and adjustment made in the voltage adjustment part may be executed in accordance with a result of detection by the voltage detection part.

This configuration permits detection of the degree of voltage drop in the LED circuit and execution of voltage adjustment in the voltage adjustment part in accordance with a result of this detection. Moreover, recognizing the degree of voltage drop in the LED circuit permits predicting the degree of voltage drop in the constant current circuit part. This therefore makes it easier to execute the voltage adjustment so that the voltage drop to be dissipated by the constant current circuit part becomes appropriate.

An LED driver according to another aspect of the invention feeds an electric power to a plurality of lines of LED circuits, each of which is either of a single LED and a plurality of LEDs serially connected together. The LED driver includes: a plurality of constant current circuit parts respectively serially connected to the LED circuits for the respective lines and each adjusting a current flowing from an upstream to a downstream side thereof to a predetermined value; and a plurality of voltage adjustment parts each adjusting a potential difference between the upstream and downstream sides with a switching regulator; and a connecting member serially and switchably connecting each of the constant current circuit parts to any of the plurality of voltage adjustment parts.

This configuration makes it easy to keep a current flowing to the LED circuit at a predetermined value by the constant current circuit part. Moreover, since the voltage adjustment part is serially connected to the constant current circuit part, voltage adjustment by the voltage adjustment part so that voltage drop to be dissipated by the constant current circuit part becomes more appropriate permits reducing the dissipation by the constant current circuit part. Here, “lines” refer to the LED circuits which are in parallel to each other.

The voltage adjustment part adjusts a voltage with a switching regulator. This therefore permits minimizing unnecessary power consumption associated with step-down processing, and also makes it easy to, even in case of a voltage value change, respect the permitted loss by keeping constant the dissipation by the constant current circuit part following this change.

Furthermore, each of the constant current circuit parts can be serially and switchably connected to any of a plurality of voltage adjustment parts. This therefore makes it easy to execute appropriate voltage adjustments in accordance with the respective lines by providing different voltage adjustment parts to be connected to the respective lines even when the required voltage is different for the different lines.

In the configuration described above, the LED driver may further include a voltage detection part for detecting a degree of voltage drop in the constant current circuit part, and the connecting member may execute the switching in accordance with a result of detection by the voltage detection part.

This configuration permits execution of switching in the connecting member in accordance with the degree of voltage drop in the constant current circuit part. This therefore makes it easier to execute the switching so that the voltage drop to be dissipated by the constant current circuit part becomes appropriate.

In the configuration described above, the LED driver may further include a voltage detection part for detecting a degree of voltage drop in the LED circuit, and the connecting member may execute the switching in accordance with a result of detection by the voltage detection part.

This configuration permits detection of the degree of voltage drop in the LED circuit and execution of switching in the voltage adjustment part in accordance with a result of this detection. Moreover, recognizing the degree of voltage drop in the LED circuit permits predicting the degree of voltage drop in the constant current circuit part. This therefore makes it easier to execute the switching so that the voltage drop to be dissipated by the constant current circuit part becomes appropriate.

An LED driver according to still another aspect of the invention feeds an electric power to an LED circuit, which is either of a single LED or a plurality of LEDs serially connected together. The LED driver includes: a constant current circuit part serially connected to the LED circuit and adjusting a current from an upstream to a downstream sides thereof to a predetermined value; a first voltage adjustment part adjusting a potential difference between the upstream and downstream sides with a switching regulator; a second voltage adjustment part adjusting a potential difference between the upstream and downstream sides with a linear regulator; and a connecting member serially and switchably connecting either of the first voltage adjustment part and the second adjustment part to the constant current circuit part.

This configuration makes it easy to keep a current flowing to the LED circuit at a predetermined value by the constant current circuit part. Moreover, since the first or second voltage adjustment part is serially connected to the constant current circuit part, voltage adjustment by the voltage adjustment part so that voltage drop to be dissipated by the constant current circuit part becomes appropriate permits reducing the dissipation by the constant current circuit part.

Through the connecting member, the first voltage adjustment part that adjusts a voltage with a switching regulator excellent in reducing the power consumption and the second voltage adjustment part that adjusts a voltage with a linear regulator excellent in reducing unnecessary radiation can be switchably connected to the constant current circuit part. This therefore makes it easy to achieve more appropriate voltage adjustment in accordance with condition.

In the configuration described above, the LED driver may further include a voltage detection part for detecting a degree of voltage drop in the constant current circuit part, and the connecting member may execute the switching in accordance with a result of detection by the voltage detection part.

This configuration permits execution of switching in the connecting member in accordance with the degree of voltage drop in the constant current circuit part. This therefore makes it easier to execute the switching so that the more appropriate voltage adjustment part is connected in accordance with condition of the voltage drop to be dissipated by the constant current circuit part.

In the configuration described above, the LED driver may further include a voltage detection part for detecting a degree of voltage drop in the LED circuit, and the connecting member may execute the switching in accordance with a result of detection by the voltage detection part.

This configuration permits detection of the degree of voltage drop in the LED circuit and execution of switching in the voltage adjustment part in accordance with a result of this detection. Moreover, recognizing the degree of voltage drop in the LED circuit permits predicting the degree of voltage drop in the constant current circuit part. This therefore makes it easier to execute the switching so that the more appropriate voltage adjustment part is connected in accordance with condition of the voltage drop to be dissipated by the constant current circuit part.

An LED driver according to still another aspect of the invention feeds an electric power to a plurality of lines of LED circuits, each of which is either of a single LED and a plurality of LEDs serially connected together. The LED driver includes: a plurality of constant current circuit parts respectively serially connected to the LED circuits for the respective lines and each adjusting a current flowing from an upstream to a downstream side thereof to a predetermined value; a voltage adjustment part adjusting a potential difference between the upstream and downstream sides with a switching regulator; and a connecting member switchably connecting each of the constant current circuit parts to any of the LED circuits for the respective lines.

As this configuration, more specifically, a switching control part for causing the connecting member to execute the switching at predetermined intervals may be further included.

This configuration permits connection of either of the LED circuits for the respective lines to the voltage adjustment part by switching them at the predetermined intervals. Thus, providing configuration such that an electric power is fed to the LED circuit via the voltage adjustment part permits achieving dynamic illumination by which the LED circuits for the respective lines are sequentially illuminated, which in turn permits reducing the power consumption.

Providing an electronic device including the LED driver according to the configuration described above permits achieving an electronic device capable of benefiting from the advantages provided by this configuration.

Providing an LED emitter including the LED driver according to the configuration described above and an LED for emitting light by being fed with an electric power from the LED driver permits achieving an LED emitter that can benefit from the advantages provided by this configuration.

### BRIEF DESCRIPTION OF THE DRAWINGS

The above and other objects and characteristics of the present invention will be more clarified by the following description regarding the preferred embodiments and the accompanying drawings showing the following.

FIG. 1 is a configuration diagram of an LED driver according to a first embodiment of the invention;

FIG. 2 is another configuration diagram of the LED driver according to the first embodiment of the invention;

FIG. 3 is a configuration diagram of an LED driver according to a second embodiment of the invention;

FIG. 4 is another configuration diagram of the LED driver according to the second embodiment of the invention;

FIG. 5 is a configuration diagram of an LED driver according to a third embodiment of the invention;

FIG. 6 is a configuration diagram of an LED driver according to a fourth embodiment of the invention;

FIG. 7 is another configuration diagram of the LED driver according to the fourth embodiment of the invention;

FIG. 8 is a configuration diagram of an LED driver according to a fifth embodiment of the invention;

FIG. 9 is a configuration diagram of a conventional LED driver employing a resistance driving method; and

FIG. 10 is a configuration diagram of a conventional LED driver employing a constant current driving method.

### DETAILED DESCRIPTION OF PREFERRED EMBODIMENTS

As the embodiments of the present invention, the first to fifth embodiments will be described below separately from each other.

### First Embodiment

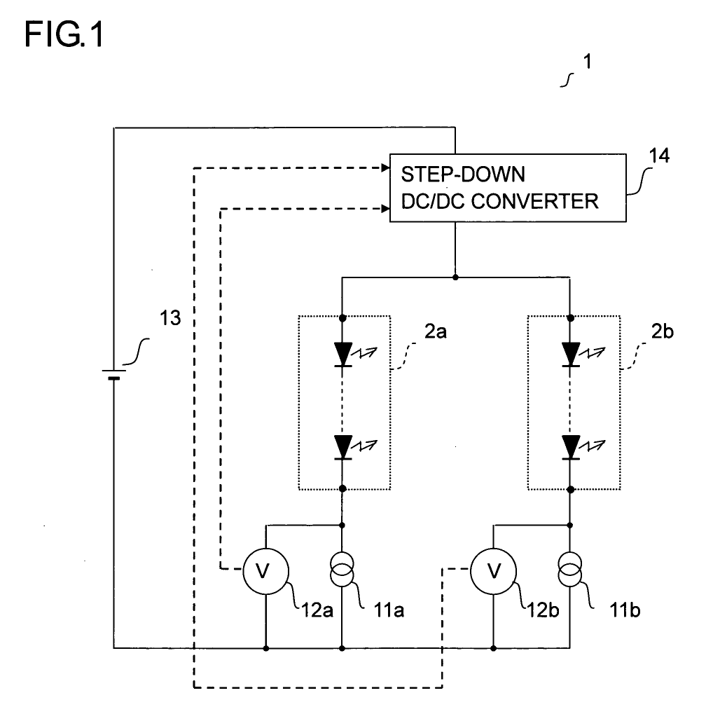

Configuration of an LED driver according to the first embodiment of the invention will be described with reference to FIG. 1. As in this figure, the LED driver 1 is provided with constant current circuit parts (11a and 11b), voltage detection parts (12a and 12b), a constant voltage source 13, and a step-down DC/DC converter 14. In the LED driver 1, as shown in FIG. 1, a first-line LED group 2a and a second-line LED group 2b are connected in parallel to each other.

More specifically, the first-line LED group 2a is connected between the downstream side of the step-down DC/DC converter 14 and the upstream side of the constant current circuit part 11a. The second-line LED group 2b is connected between the downstream side of the step-down DC/DC converter 14 and the upstream side of the constant current circuit part 11b.

The constant current circuit parts (11a and 11b) are each formed of a constant current circuit that adjusts a current flowing therethrough (that is, a current flowing from the upstream to downstream sides thereof) to a predetermined value, and have upstream sides thereof respectively connected to the LED groups (2a and 2b) and have downstream sides thereof connected to the negative side of the constant voltage source 13. Specifically, the constant current circuit part 11a is serially connected to the first-line LED group 2a, and the constant current circuit part 11b is serially connected to the second-line LED group 2b. As a result, the constant current circuit parts (11a and 11b) can respectively adjust currents flowing to the LED groups (2a and 2b) to respective predetermined amounts.

The voltage detection part 12a detects a voltage across the constant current circuit part 11a. The voltage detection part 12b detects a voltage across the constant current circuit part 11b. Results of these detections are transmitted to the step-down DC/DC converter 14.

The constant voltage source 13 is formed of a battery or the like, and maintains constant state of a voltage thereacross. The negative side terminal of the constant voltage source 13 is connected to the downstream sides of the respective constant current circuit parts (11a and 11b), and the positive side terminal thereof is connected to the upstream side of the step-down DC/DC converter 14.

The step-down DC/DC converter 14, with a switching regulator, steps down an upstream side voltage and then outputs it from the downstream side. The switching regulator adjusts a voltage through a duty ratio concerned with circuit ON/OFF switching, and thus is known to be capable of reducing unnecessary power consumption more than, for example, the one that achieves stepping down by inserting an external resistor. Moreover, the step-down DC/DC converter 14 is provided with a voltage controller for controlling step-down amounts in accordance with results of detection by the voltage detection parts (12a and 12b).

This voltage controller controls the step-down amounts so that the most appropriate possible voltages are respectively applied to the constant current circuit parts (11a and 11b). More specifically, the voltage controller detects each of a difference between a target voltage (voltage considered to cause no unnecessary voltage drop in the constant current circuit part) and a detected voltage in the constant current circuit part 11a and a difference between a target voltage and a detected voltage in the constant current circuit part 11b, and controls these detected values at their respective minimum possible values. For example, when the detected voltage is excessively higher than the target voltage, the voltage controller increases the amount of step-down in the step-down DC/DC converter 14 to bring the detected voltage closer to the target value.

With the LED driver 1 configured as described above, a current flowing to the first-line LED group 2a can be kept substantially constant by the constant current circuit part 11a, regardless of the degree of voltage drop occurring in this LED group. Similarly, a current flowing to the second-line LED group 2b can be kept substantially constant by the constant current circuit part 11b, regardless of the degree of voltage drop occurring in this LED group.

Further, even if a voltage fed from the constant voltage source 13 is too large or the voltage drop in the LED groups varies, potential differences to be dissipated by the respective constant current circuit parts (11a and 11b) can be minimized by setting the amounts of step-down in the step-down DC/DC converter 14 appropriately (so as to cancel unnecessary amounts of voltage drop in the constant current circuit parts).

As in this embodiment in particular, by setting the amounts of step-down in the step-down DC/DC converter 14 based on voltages across the respective constant current circuit parts (11a and 11b) so as to minimize the potential differences to be dissipated by the respective constant current circuit parts (11a and 11b), appropriate amounts of step-down can be set with high accuracy.

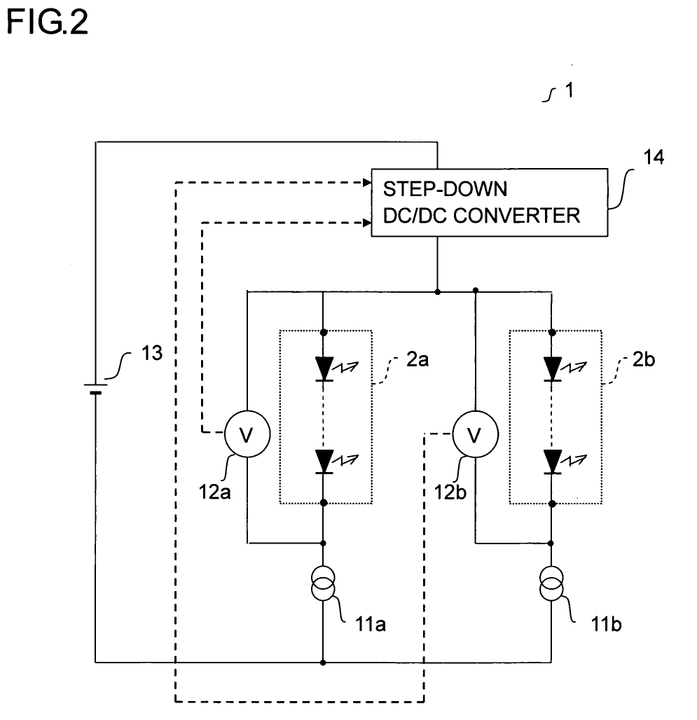

Moreover, in this embodiment, the voltage detection parts (12a and 12b) respectively detect voltages across the respective constant current circuit parts (11a and 11b), but they may be adapted to respectively detect voltages across the respective LED groups (2a and 2b). FIG. 2 shows a configuration diagram of an LED driver configured in this manner.

With the configuration as in this figure, a total sum of voltage drop V_{F} in the LED groups (2a and 2b) can be respectively detected by the voltage detection parts. Thus, recognizing a voltage generated by the constant voltage source 13 permits detection of voltages respectively applied to the constant current circuit parts (11a and 11b). This permits setting the amounts of step down in the step-down DC/DC converter 14 so as to minimize the potential differences to be dissipated the respective constant current circuit parts (11a and 11b).

### Second Embodiment

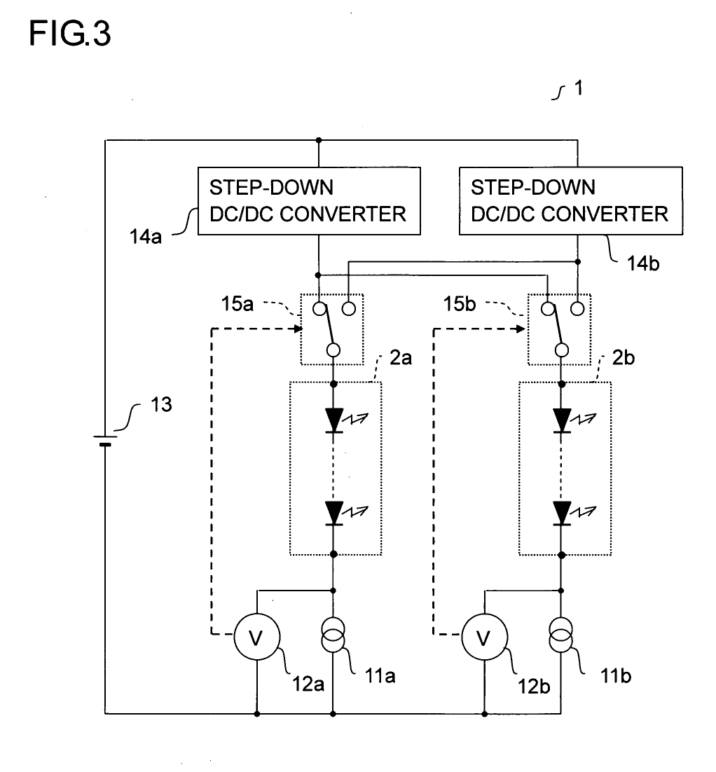

Next, configuration of an LED driver according to the second embodiment of the invention will be described with reference to FIG. 3. As in this figure, the LED driver 1 is provided with constant current circuit parts (11a and 11b), voltage detection parts (12a and 12b), a constant voltage source 13, a step-down DC/DC converter 14, switching connection parts (15a and 15b), and the like. In the LED driver 1, as shown in FIG. 3, a first-line LED group 2a and a second-line LED group 2b are connected in parallel to each other.

More specifically, the first-line LED group 2a is connected between the downstream side of the switching connection part 15a and the upstream side of the constant current circuit part 11a. The second-line LED group 2b is connected between the downstream side of the switching connection part 15b and the upstream side of the constant current circuit part 11b.

The constant current circuit parts (11a and 11b) have upstream sides thereof respectively connected to the LED groups (2a and 2b) and have downstream sides thereof connected to the negative side of the constant voltage source 13. Specifically, the constant current circuit part 11a is serially connected to the first-line LED group 2a, and the constant current circuit part 11b is serially connected to the second-line LED group 2b. As a result, the constant current circuit parts (11a and 11b) can respectively adjust currents flowing to the LED groups (2a and 2b) to respective predetermined amounts.

The voltage detection part 12a detects a voltage across the constant current circuit part 11a. The result of this detection is transmitted to the switching connection part 15a. The voltage detection part 12b detects a voltage across the constant current circuit part 11b. The result of this detection is transmitted to the switching connection part 15b.

The constant voltage source 13 is formed of a battery or the like, and maintains constant state of a voltage thereacross. The negative side terminal of the constant voltage source 13 is connected to the downstream sides of the respective constant current circuit parts (11a and 11b), and the positive side terminal thereof is connected to the upstream sides of the respective step-down DC/DC converters (14a and 14b).

Each of the step-down DC/DC converters (14a and 14b), with a switching regulator, steps down a voltage inputted from the upstream side and then outputs it from the downstream side. The amounts of step-down in the step-down DC/DC converters (14a and 14b) are controlled independently from each other, thus permitting providing mutually different amounts of step-down.

The switching connection part 15a can switchably connect the first-line LED group 2a to either of the plurality of step-down DC/DC converters (14a and 14b). Moreover, the switching connection part 15a is provided with a switching controller for causing execution of this switching in accordance with a result of detection by the voltage detection part 12a. The switching connection part 15b can switchably connect the second-line LED group 2b to either of the plurality of step-down DC/DC converters (14a and 14b). Moreover, the switching connection part 15b is provided with a switching controller for causing execution of this switching in accordance with a result of detection by the voltage detection part 12b.

These switching controllers, for example, when the LED groups are tentatively respectively connected to the step-down DC/DC converters, respectively detect differences between the respective target values and respective detected voltages in the constant current circuit parts. Thereafter, the step-down DC/DC converter exhibiting a minimum result of this detection is selected and then switching is executed so that this is connected to the corresponding LED group.

With the LED driver 1 configured as described above, a current flowing to the first-line LED group 2a can be kept substantially constant by the constant current circuit part 11a, regardless of the degree of voltage drop occurring in this LED group. Similarly, a current flowing to the second-line LED group 2b can be kept substantially constant by the constant current circuit part 11b, regardless of the degree of voltage drop occurring in this LED group.

Further, even if a voltage fed from the constant voltage source 13 is too large or the voltage drop in the LED groups varies, potential differences to be dissipated by the respective constant current circuit parts (11a and 11b) can be minimized by setting the amounts of step-down in the step-down DC/DC converters connected therewith appropriately (so as to cancel unnecessary amounts of voltage drop in the constant current circuit parts).

Each of the constant current circuit parts (11a and 11b) can be serially and switchably connected to either of the plurality of step-down DC/DC converters (14a and 14b). Thus, even when the lines have different required voltages, the different step-down DC/DC converters to be connected can be provided for the different lines, thus permitting execution of appropriate voltage adjustments in accordance with the respective lines.

As in this embodiment in particular, detection of voltages across the respective constant current circuit parts (11a and 11b) corresponding to the lines makes it easy to judge whether or not the required voltage is different for the different lines. Thus, switching the step-down DC/DC converter to be actually connected based on the result of this detection can make this switching more adequate.

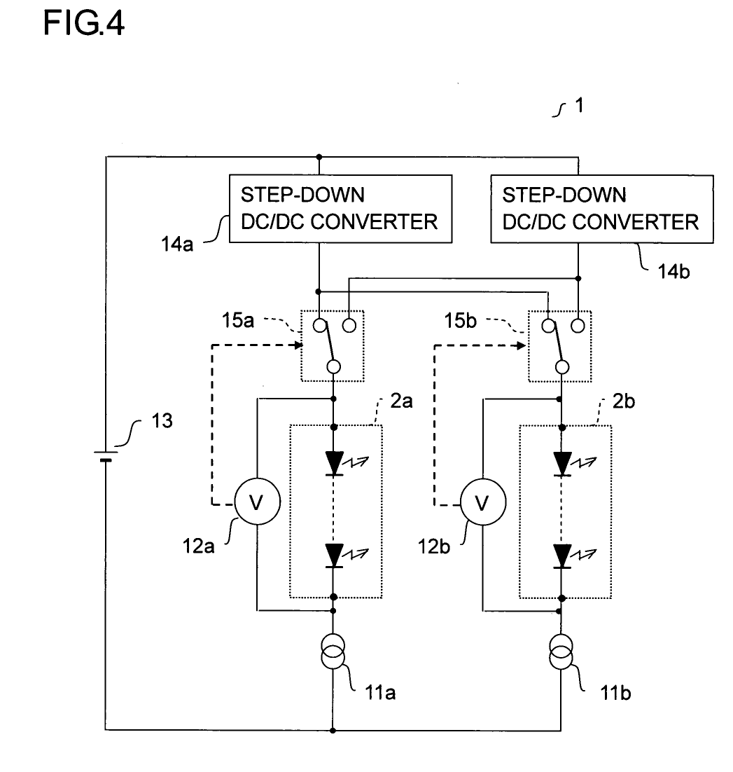

Moreover, in this embodiment, the voltage detection parts (12a and 12b) respectively detect voltages across the respective constant current circuit parts (11a and 11b), but alternatively they may be adapted to respectively detect voltages across the respective LED groups (2a and 2b). FIG. 4 shows a configuration diagram of an LED driver configured in this manner.

With the configuration as in this figure, a total sum of voltage drop V_{F} in the LED groups (2a and 2b) for the respective lines can be detected by the voltage detection parts. This makes it easy to judge whether or not the required voltage is different for different lines, thus permitting more adequately switching the step-down DC/DC converter to be connected.

Also in this embodiment, as in the first embodiment described above, the amounts of step-down in the step-down DC/DC converters may be adjusted based on results of detection by the voltage detection parts. That is, the results of detection by the voltage detection parts can be reflected not only on switching processing at the switching connection parts but also on step-down processing to thereby minimize the dissipation in the constant current circuit parts and the like.

### Third Embodiment

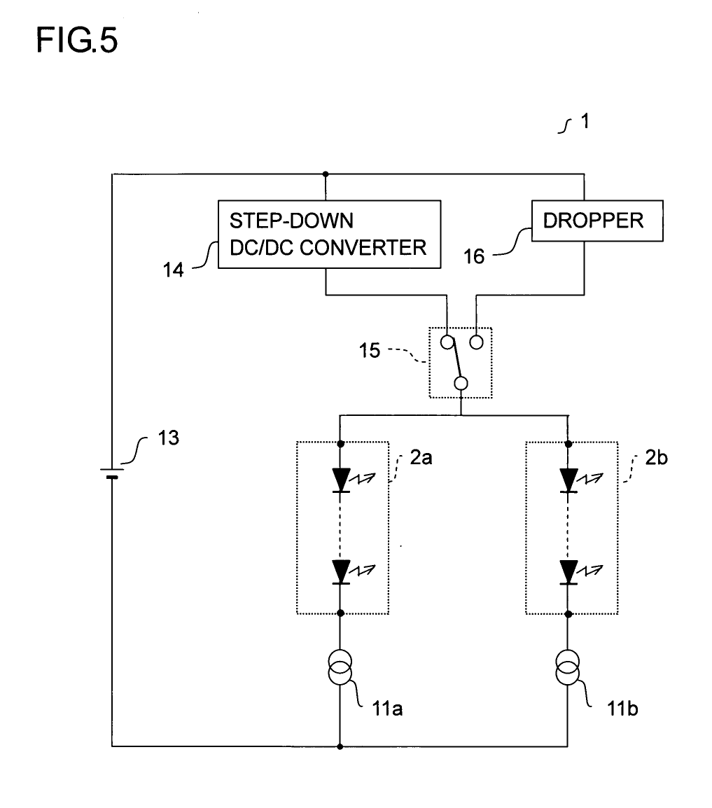

Next, configuration of an LED driver according to the third embodiment of the invention will be described with reference to FIG. 5. As in this figure, the LED driver 1 is provided with constant current circuit parts (11a and 11b), a constant voltage source 13, a step-down DC/DC converter 14, a switching connection part 15, and a dropper 16. In the LED driver 1, as shown in FIG. 5, a first-line LED group 2a and a second-line LED group 2b are connected in parallel to each other.

More specifically, the first-line LED group 2a is connected between the downstream side of the switching connection part 15 and the upstream side of the constant current circuit part 11a. The second-line LED group 2b is connected between the downstream side of the switching connection part 15 and the upstream side of the constant current circuit part 11b.

The constant current circuit parts (11a and 11b) have upstream sides thereof respectively connected to the LED groups (2a and 2b) and have downstream sides thereof connected to the negative side of the constant voltage source 13. Specifically, the constant current circuit part 11a is serially connected to the first-line LED group 2a, and the constant current circuit part 11b is serially connected to the second-line LED group 2b. As a result, the constant current circuit parts (11a and 11b) can respectively adjust currents flowing to the LED groups (2a and 2b) to respective predetermined amounts.

The constant voltage source 13 is formed of a battery or the like, and maintains constant state of a voltage thereacross. The negative side terminal of the constant voltage source 13 is connected to the downstream sides of the respective constant current circuit parts (11a and 11b), and the positive side terminal thereof is connected to the upstream sides of the step-down DC/DC converter 14 and the dropper 16.

The step-down DC/DC converter 14, with a switching regulator, steps down a voltage inputted from the upstream side and then outputs it from the downstream side. The dropper 16, with a linear regulator, steps down a voltage inputted from the upstream side and then outputs it from the downstream side. The linear regulator is known to be capable of reducing generation of unnecessary radiation and electric noise more than a switching regulator or the like configured to achieve circuit ON/OFF switching.

The switching connection part 15 can switchably connect the upstream sides of the LED groups (2a and 2b) for the respective lines to either the downstream side of the step-down DC/DC converter 14 or the downstream side of the dropper 16. This switching may be adapted to be performed in response to user instructions given through, for example, button operation or the like, or may be adapted to be performed in accordance with results of detection on voltage states of the constant current circuit parts (11a and 11b), although not limited thereto.

With the LED driver 1 configured as described above, a current flowing to the first-line LED group 2a can be kept substantially constant by the constant current circuit part 11a, regardless of the degree of voltage drop occurring in this LED group. Similarly, a current flowing to the second-line LED group 2b can be kept substantially constant by the constant current circuit part 11b, regardless of the degree of voltage drop occurring in this LED group.

Further, even if a voltage fed from the constant voltage source 13 is too large or the voltage drop in the LED groups varies, differences to be dissipated by the respective constant current circuit parts (11a and 11b) can be minimized through connection with the step-down DC/DC converter 14 or the dropper 16. That is, potential differences to be dissipated by the respective constant current circuit parts (11a and 11b) are minimized by setting the amounts of step-down in the step-down DC/DC converter 14 or the dropper 16 appropriately (so as to cancel unnecessary amounts of voltage drop in the constant current circuit parts).

In this embodiment, in a case where the power consumption is desired to be reduced to a small level or when dissipation by the constant current circuit part is relatively large, it is possible, through connection with the step-down DC/DC converter 14, to reduce the potential difference to be dissipated by the constant current circuit part while minimizing the power consumption.

Also in this embodiment, as in the first embodiment described above, voltage detection parts for detecting voltages respectively applied to the constant current circuit parts (11a and 11b) and the LED groups (2a and 2b) may be provided so that the amounts of step-down in the step-down DC/DC converter 14 or the dropper 16 may be adjusted based on results of detection by the voltage detection parts. That is, the results of detection by the voltage detection parts can be reflected not only on switching processing at the switching connection part but also on step-down processing to thereby minimize the dissipation in the constant current circuit parts and the like.

### Fourth Embodiment

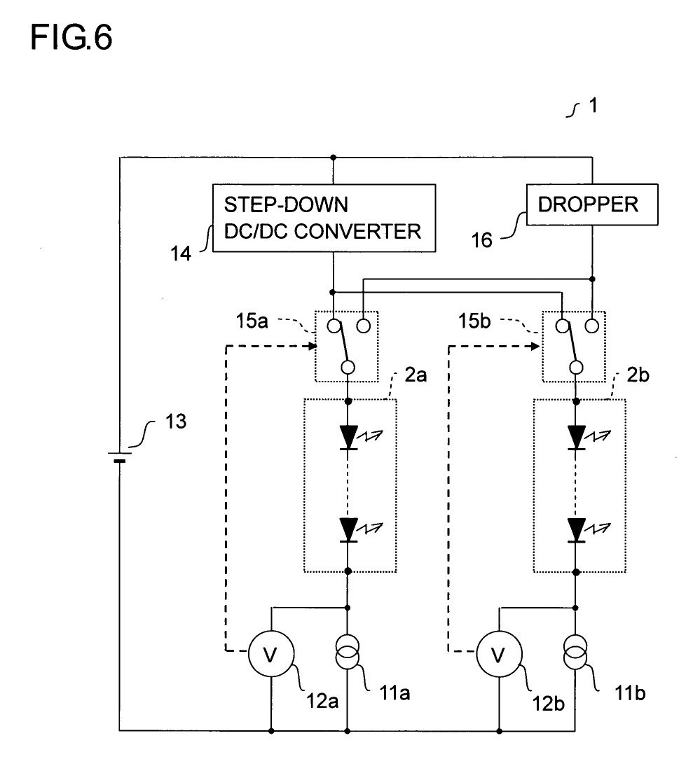

Next, configuration of an LED driver according to the fourth embodiment of the invention will be described with reference to FIG. 6. As in this figure, the LED driver 1 is provided with constant current circuit parts (11a and 11b), voltage detection parts (12a and 12b), a constant voltage source 13, a step-down DC/DC converter 14, switching connection parts (15a and 15b), a dropper 16, and the like. In the LED driver 1, as shown in FIG. 6, a first-line LED group 2a and a second-line LED group 2b are connected in parallel to each other.

More specifically, the first-line LED group 2a is connected between the downstream side of the switching connection part 15a and the upstream side of the constant current circuit part 11a. The second-line LED group 2b is connected between the downstream side of the switching connection part 15b and the upstream side of the constant current circuit part 11b.

The constant current circuit parts (11a and 11b) have upstream sides thereof respectively connected to the LED groups (2a and 2b) and have downstream sides thereof connected to the negative side of the constant voltage source 13. Specifically, the constant current circuit part 11a is serially connected to the first-line LED group 2a, and the constant current circuit part 11b is serially connected to the second-line LED group 2b. As a result, the constant current circuit parts (11a and 11b) can respectively adjust currents flowing to the LED groups (2a and 2b) to respective predetermined amounts.

The constant voltage source 13 is formed of a battery or the like, and maintains constant state of a voltage thereacross. The negative side terminal of the constant voltage source 13 is connected to the downstream sides of the respective constant current circuit parts (11a and 11b), and the positive side terminal thereof is connected to the upstream sides of the step-down DC/DC converter 14 and the dropper 16.

The step-down DC/DC converter 14 is provided with a switching regulator, and steps down, through control of a duty ratio in the switching, a voltage inputted to the upstream side and then outputs it from the downstream side. The dropper 16, with a linear regulator, steps down a voltage inputted to the upstream side and then outputs it from the downstream side.

The switching connection part 15a switchably connects the upstream side of the first-line LED group 2a to either the downstream side of the step-down DC/DC converter 14 or the downstream side of the dropper 16. Moreover, the switching connection part 15a is provided with a switching controller for causing execution of this switching in accordance with a result of detection by the voltage detection part 12a. The switching connection part 15b switchably connects the upstream side of the second-line LED group 2b to either the downstream side of the step-down DC/DC converter 14 or the downstream side of the dropper 16. Moreover, the switching connection part 15b is provided with a switching controller for causing execution of this switching in accordance with a result of detection by the voltage detection part 12b.

These switching controllers each detect a difference between a target voltage and a detected voltage in the corresponding constant current circuit part. Then based on the result of this detection, if a potential difference to be dissipated by the constant current circuit part is equal to or larger than a given value, the switching controller causes execution of switching so as to connect the step-down DC/DC converter 14 to the LED group, while if this difference is less than the given value, the switching controller causes execution of switching so as to connect the dropper 16 to the LED group.

Consequently, when the potential difference to be dissipated by the constant current circuit part is relatively large (which typically cause an increase in the power consumption), stepping down with the step-down DC/DC converter 14 can minimize a further increase in the power consumption. When the potential difference to be dissipated by the constant current circuit part is relatively small, stepping down with the dropper 16 can focus on reducing generation of unnecessary radiation.

With the LED driver 1 configured as described above, a current flowing to the first-line LED group 2a can be kept substantially constant by the constant current circuit part 11a, regardless of the degree of voltage drop occurring in this LED group. Similarly, a current flowing to the second-line LED group 2b can be kept substantially constant by the constant current circuit part 11b, regardless of the degree of voltage drop occurring in this LED group.

Further, even if a voltage fed from the constant voltage source 13 is too large or the voltage drop in the LED groups varies, potential differences to be dissipated by the respective constant current circuit parts (11a and 11b) can be minimized through connection of the step-down DC/DC converter 14 or the dropper 16. That is, the potential differences to be dissipated by the respective constant current circuit parts (11a and 11b) are minimized by setting the amounts of step-down in the step-down DC/DC converter 14 or the dropper 16 appropriately (so as to cancel unnecessary amounts of voltage drop in the constant current circuit parts).

As in this embodiment in particular, selecting, based on the voltage across each of the constant current circuit parts (11a and 11b), which of the step-down DC/DC converter 14 and the dropper is to be connected can make this selection more adequate.

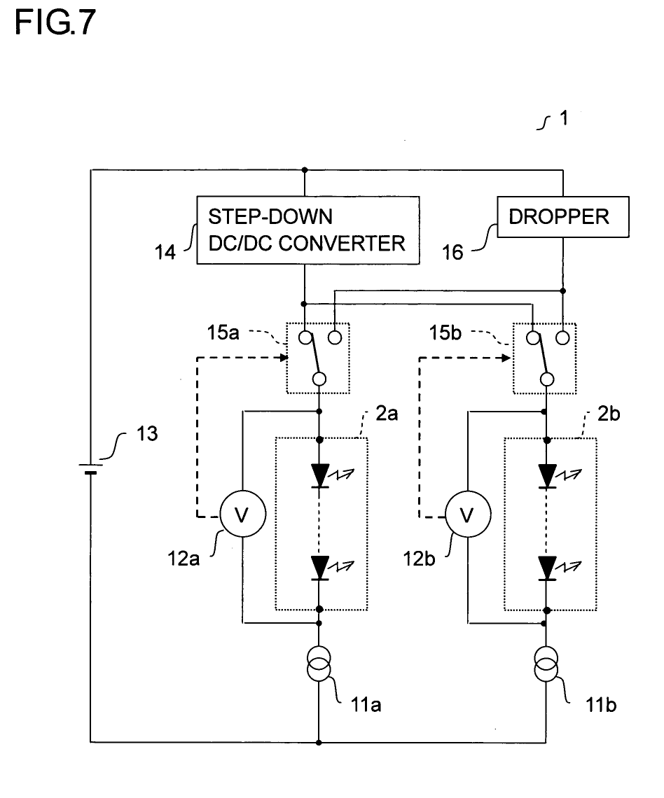

Moreover, in this embodiment, the voltage detection parts (12a and 12b) respectively detect voltages across the respective constant current circuit parts (11a and 11b), but they may be adapted to respectively detect voltages across the respective LED groups (2a and 2b). FIG. 7 shows a configuration diagram of an LED driver configured in this manner.

With the configuration as in this figure, a total sum of voltage drop V_{F} in the LED groups (2a and 2b) can be detected by the voltage detection parts. Thus, recognizing a voltage to be generated by the constant voltage source 13 permits detection of voltages respectively applied to the constant current circuit parts (11a and 11b). This permits more adequate selection on which of the step-down DC/DC converter 14 and the dropper is to be connected.

Also in this embodiment, as in the first embodiment described above, the amounts of step-down in the step-down DC/DC converter 14 or the dropper 16 may be adjusted based on results of detection by the voltage detection parts. That is, the results of detection by the voltage detection parts can be reflected not only on switching processing at the switching connection parts but also on step-down processing to thereby minimize the dissipation in the constant current circuit parts and the like.

### Fifth Embodiment

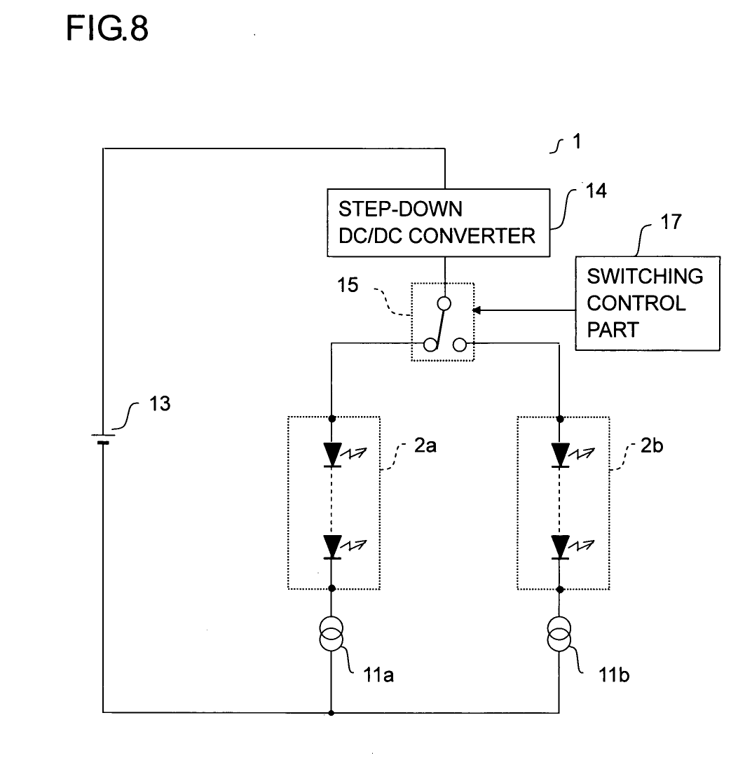

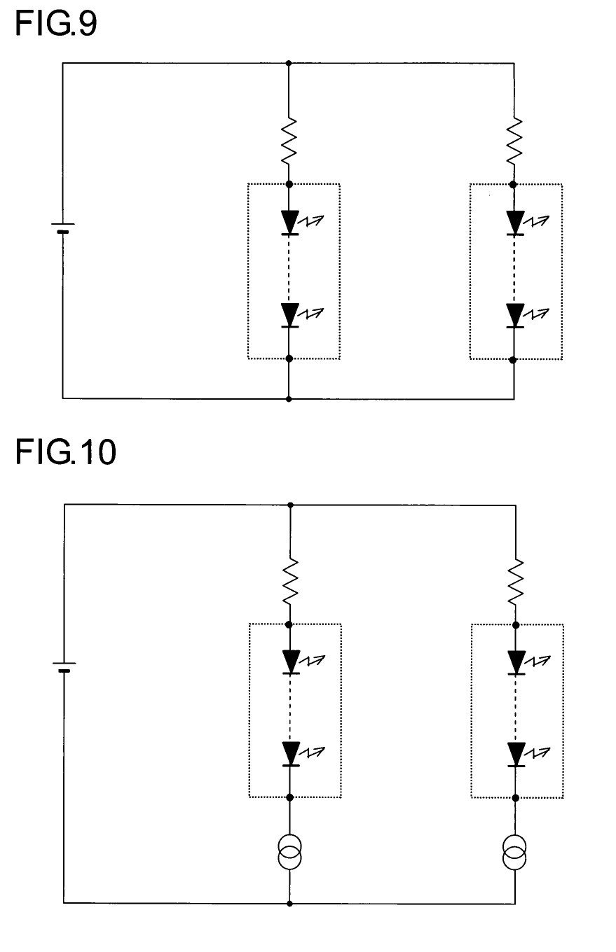

Next, configuration of an LED driver according to the fifth embodiment of the invention will be described with reference to FIG. 8. As in this figure, the LED driver 1 is provided with constant current circuit parts (11a and 11b), a constant voltage source 13, a step-down DC/DC converter 14, a switching connection part 15, a switching control part 17, and the like. In the LED driver 1, as shown in FIG. 8, a first-line LED group 2a and a second-line LED group 2b are connected in parallel to each other.

More specifically, the first-line LED group 2a is connected between the downstream side of the switching connection part 15 and the upstream side of the constant current circuit part 11a. The second-line LED group 2b is connected between the downstream side of the switching connection part 15 and the upstream side of the constant current circuit part 11b.

The constant current circuit parts (11a and 11b) have upstream sides thereof respectively connected to the LED groups (2a and 2b) and have downstream sides thereof connected to the negative side of the constant voltage source 13. Specifically, the constant current circuit part 11a is serially connected to the first-line LED group 2a, and the constant current circuit part 11b is serially connected to the second-line LED group 2b. As a result, the constant current circuit parts (11a and 11b) can respectively adjust currents flowing to the LED groups (2a and 2b) to respective predetermined amounts.

The constant voltage source 13 is formed of a battery or the like, and maintains constant state of a voltage thereacross. The negative side terminal of the constant voltage source 13 is connected to the downstream sides of the respective constant current circuit parts (11a and 11b), and the positive side terminal thereof is connected to the upstream side of the step-down DC/DC converter 14.

The step-down DC/DC converter 14, with a switching regulator, steps down a voltage inputted from the upstream side and then outputs it from the downstream side. The switching connection part 15 switchably connects the step-down DC/DC converter 14 to either of the first LED group 2a and the second LED group 2b. This switching is executed based on control by the switching control part 17.

The switching control part 17 controls switching for connection in the switching connection part 15. More specifically, the switching control part 17 controls the switching connection part 15 so as to switch the connection destinations alternately at predetermined intervals (for example, 60 Hz).

With the LED driver 1 configured as described above, a current flowing to the first-line LED group 2a can be kept substantially constant by the constant current circuit part 11a, regardless of the degree of voltage drop occurring in this LED group. Similarly, a current flowing to the second-line LED group 2b can be kept substantially constant by the constant current circuit part 11b, regardless of the degree of voltage drop occurring in this LED group.

Further, even if a voltage fed from the constant voltage source 13 is too large or the voltage drop in the LED groups varies, potential differences to be dissipated by the respective constant current circuit parts (11a and 11b) can be minimized by setting the amounts of step-down in the step-down DC/DC converter 14 appropriately (so as to cancel unnecessary amounts of voltage drop in the constant current circuit parts).

In this embodiment, dynamic illumination for alternately illuminating the LED groups (2a and 2b) for respective lines can be achieved through control by the switching control part 17. This permits reducing power consumption even while illuminating a plurality of LED groups. Shared use of the step-down DC/DC converter 14 by the LED groups for the respective lines provides simpler circuit configuration than configuration in which a step-down device is provided for each line.

Also in this embodiment, as in the first embodiment described above, voltage detection parts for detecting voltages respectively applied to the constant current circuit parts (11a and 11b) and the LED groups (2a and 2b) may be provided so that the amounts of step-down in the step-down DC/DC converter 14 may be adjusted based on results of detection by the voltage detection parts. That is, the results of detection by the voltage detection parts can be reflected not only on switching processing at the switching connection part but also on step-down processing to thereby minimize the dissipation in the constant current circuit parts and the like.

### [Discussion]

The embodiments of the invention has been described above, but it should be understood that the scope of the invention is not limited to these described above. Thus, various modifications can be made without departing from the spirit of the invention. Moreover, the technologies adopted by the embodiments can be used in combination as long as it does not produce any inconsistency.

The embodiments have been described, referring to an LED driver that feeds an electric power to LED groups for respective lines (a plurality of LED serially connected together). However, instead of the LED groups, a single LED may be used. Moreover, intended use of this LED driver can include: being mounted in various electronic devices, and being connected with an LED, which emits light by being fed with an electric power from the LED driver, to achieve an LED device. Further the LED device is favorably used in an electronic device provided with an LED emitter, an LED display device, or an LED backlight display device.

With the LED driver of the invention whose embodiments have been described above, a current flowing to the LED circuit can be easily kept at a predetermined value by the constant current circuit part. Moreover, since the voltage adjustment part is serially connected to the constant current circuit part, voltage adjustment by the voltage adjustment part so that voltage drop to be dissipated by the constant current circuit part becomes appropriate permits reducing the dissipation by the constant current circuit part.

The voltage adjustment part adjusts a voltage with a switching regulator. This therefore permits minimizing unnecessary power consumption associated with step-down processing, and also makes it easy to, even in case of a voltage value change, respect the permitted loss by keeping constant the dissipation by the constant current circuit part following this change.

1. An LED driver for feeding an electric power to an LED circuit, which is either of a single LED or a plurality of LEDs serially connected together, the LED driver comprising:
a constant current circuit part serially connected to the LED circuit, the constant current circuit part adjusting a current flowing from an upstream to a downstream side thereof to a predetermined value; and
a voltage adjustment part serially connected to the constant current circuit part, the voltage adjustment part adjusting a potential difference between the upstream and downstream sides with a switching regulator.

2. The LED driver according to claim 1, further comprising a voltage detection part for detecting a degree of voltage drop in the constant current circuit part,
wherein adjustment made in the voltage adjustment part is executed in accordance with a result of detection by the voltage detection part.

3. The LED driver according to claim 1, further comprising a voltage detection part for detecting a degree of voltage drop in the LED circuit,
wherein adjustment made at the voltage adjustment part is executed in accordance with a result of detection by the voltage detection part.

4. An LED driver for feeding an electric power to a plurality of lines of LED circuits, each of which is either of a single LED and a plurality of LEDs serially connected together, the LED driver comprising:
a plurality of constant current circuit parts respectively serially connected to the LED circuits for the respective lines, the constant current circuit parts each adjusting a current flowing from an upstream to a downstream side thereof to a predetermined value;
a plurality of voltage adjustment parts each adjusting a potential difference between the upstream and downstream sides with a switching regulator; and
a connecting member serially and switchably connecting each of the constant current circuit parts to any of the plurality of voltage adjustment parts.

5. The LED driver according to claim 4, further comprising a voltage detection part for detecting a degree of voltage drop in the constant current circuit part,
wherein the connecting member executes the switching in accordance with a result of detection by the voltage detection part.

6. The LED driver according to claim 4, further comprising a voltage detection part for detecting a degree of voltage drop in the LED circuit,
wherein the connecting member executes the switching in accordance with a result of detection by the voltage detection part.

7. An LED driver for feeding an electric power to an LED circuit, which is either of a single LED or a plurality of LEDs serially connected together, the LED driver comprising:
a constant current circuit part serially connected to the LED circuit, the constant current circuit part adjusting a current from an upstream to a downstream sides thereof to a predetermined value;
a first voltage adjustment part adjusting a potential difference between the upstream and downstream sides with a switching regulator;
a second voltage adjustment part adjusting a potential difference between the upstream K and downstream sides with a linear regulator; and
a connecting member serially and switchably connecting either of the first voltage adjustment part and the second adjustment part to the constant current circuit part.

8. The LED driver according to claim 7, further comprising a voltage detection part for detecting a degree of voltage drop in the constant current circuit part,
wherein the connecting member executes the switching in accordance with a result of detection by the voltage detection part.

9. The LED driver according to claim 7, further comprising a voltage detection part for detecting a degree of voltage drop in the LED circuit,
wherein the connecting member executes the switching in accordance with a result of detection by the voltage detection part.

10. An LED driver for feeding an electric power to a plurality of lines of LED circuits, each of which is either of a single LED and a plurality of LEDs serially connected together, the LED driver comprising:
a plurality of constant current circuit parts respectively serially connected to the LED circuits for the respective lines, the constant current circuit parts each adjusting a current flowing from an upstream to a downstream side thereof to a predetermined value;
a voltage adjustment part adjusting a potential difference between the upstream and downstream sides with a switching regulator; and
a connecting member switchably connecting each of the constant current circuit parts to any of the LED circuits for the respective lines.

11. The LED driver according to claim 10, further comprising a switching control part for causing the connecting member to execute the switching at predetermined intervals.

12. An electronic device comprising the LED driver according to claim 10.

13. An LED device comprising: the LED driver according to claim 10, and an LED emitting light by being fed with an electric power from the LED driver.

14. An electronic device comprising the LED driver according to claim 2.

15. An electronic device comprising the LED driver according to claim 3.

16. An electronic device comprising the LED driver according to claim 4.

17. An electronic device comprising the LED driver according to claim 5.

18. An electronic device comprising the LED driver according to claim 6.

19. An electronic device comprising the LED driver according to claim 7.

20. An electronic device comprising the LED driver according to claim 8.
